(19) United States
(12) Patent Application Publication
(10) Pub. No.: US 2019/0246606 A1
(43) Pub. Date: Aug. 15, 2019

(54) Dog Entertainment and Exercise Apparatus

(71) Applicants: Nathaniel Harms, Peyton, CO (US); Luke Bost, Peyton, CO (US)

(72) Inventors: Nathaniel Harms, Peyton, CO (US); Luke Bost, Peyton, CO (US)

(21) Appl. No.: 15/894,934

(22) Filed: Feb. 13, 2018

(51) Int. Cl. A01K 15/02

(52) U.S. Cl. CPC A01K 15/025; A01K 15/027

(57) ABSTRACT

A pole-based pet entertainment apparatus comprising a pole with a first end and a second end, with the first end comprising an end cap. The pole comprises at least two grip panels interposed between the first end and the second end. The end cap comprises a cable hoop ring having back and forth movement over the end cap from side-to-side of the pole. A swivel attachment attaches a cable to the cable hoop ring, with the cable comprising a terminating attachment interface with an attached pet toy opposite from the cable hoop ring.

### CROSS-REFERENCE TO RELATED APPLICATION(S)

Not applicable.

### BACKGROUND OF THE INVENTION

### 1. Field of Invention

The present invention relates to the field of dog entertainment/toy devices, more particularly to a pole with a dog toy attached.

### 2. Description of Related Art

Pet dogs have increasingly been incorporated into the daily lives of millions of Americans. Many of today's families have a pet dog firmly incorporated as an integral of the family, considered just as important in many respects as children (and for many couples largely a replacement for children).

Dog toys serve different purposes and come in many varieties such as dog bones, puppy toys, balls, tug toys, training aids, squeaky toys, discs and frisbees, plush toys, and sticks. Toy can provide puppies relief from teething, because their gums and jaws become sensitive and sore and chewing on things provides relief. For all dogs, different toys encourage exercise promoting the pet's overall health. Toys also stimulate dogs' minds, discouraging behavior problems due to boredom and excess energy, and also promote dental health.

There are a wide variety of dog toys on the market that are designed for different purposes and to accommodates the dog's characteristics such as size, activity level, chewing habits, and play style. Some toys can serve multiple functions, combining common play behaviors into a single toy, while others convert to other toys and objects, and be combined by a dog owner to create new toys for dogs to play with. Further, toys can be useful for extremely active dogs to provide both mental stimulation and physical exercise. Some examples are food delivery toys, Kongs stuffed with dog food, frozen peanut butter and/or treats, chew challenge toys, and puzzle toys.

The term “bones” can include animal bones as well as manufactured bones such as Nylabones and dental bones. Animal bones offer a lot of chewing potential, but the true nutritional benefits are derived from the soft tissues attached to the bone such as meat, cartilage, fat and connective tissue. However, animal bones pose associated dangers including broken teeth and possible ingestion of large fragments of bone which can cause serious injury or death.

Dogs generally enjoy latex and rubber dog toys, which are great for dog entertainment. Latex and rubber dog toys provide aggressive chewers with a safe way to satisfy their biting instincts. These type of toys also help keep dogs' gums and teeth clean and healthy and help improve dogs' overall oral hygiene.

Dogs will often gnaw on small tree branches and pinecones, and sticks can also be thrown for the dog to retrieve. Balls of all shapes and sizes are also a dog favorite, used for general chewing and playing fetch (same as sticks), providing fun and exercise a dog at the same time.

Despite their popularity, most dog toys have a limited life span, prone to destruction as the dog chews and pulls the toy. Wear and tear can leave some toys unusable within a week, while others may last for years. Also, when playing with the owner, most games can degenerate into tug of war or fetch, whether or not the dog toy is suitable for such games. Further, most toys come in a fixed configuration suitable for only one type of play. A dog owner may have multiple dog toys, with each used for a particular style of play.

Based on the foregoing, there is a need in the art a dog toy and training apparatus which can be configured to encompass different types of toys and increase durability and versatility.

### SUMMARY OF THE INVENTION

A pole-based pet entertainment apparatus comprising a pole with a first end and a second end, with a first end comprising an end cap. The pole comprises at least two grip panels interposed between the first end and the second end. The end cap comprises a cable hoop ring having back and forth movement over the end cap from side-to-side of the pole. A swivel attachment attaches a cable to the cable hoop ring, with the cable comprising a terminating attachment interface with an attached pet toy opposite from the cable hoop ring.

The swivel attachment comprises a snap swivel.

The terminating attachment interface comprises a snap swivel.

The cable comprises a plastic or vinyl coated stainless steel cable or wire rope.

The pole comprises bamboo, wood, plastic, acrylic, or fiberglass.

The cable is between about 3′ and 10′ long.

The pole is about 5′ long.

The cable hoop ring sliding through the end cap side-to-side.

The cable comprises a 1/16″ to ¼″ diameter coated metal cable.

The dog toy comprises a training aid.

The dog toy comprises a chew toy.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a view of the pole-based pet toy apparatus, according to an embodiment of the present invention.

### ADVANTAGES

1. Simple to use and easy to understand.

2. All ages can use this product.

3. May be used with different animals.

### DETAILED DESCRIPTION OF PREFERRED EMBODIMENTS

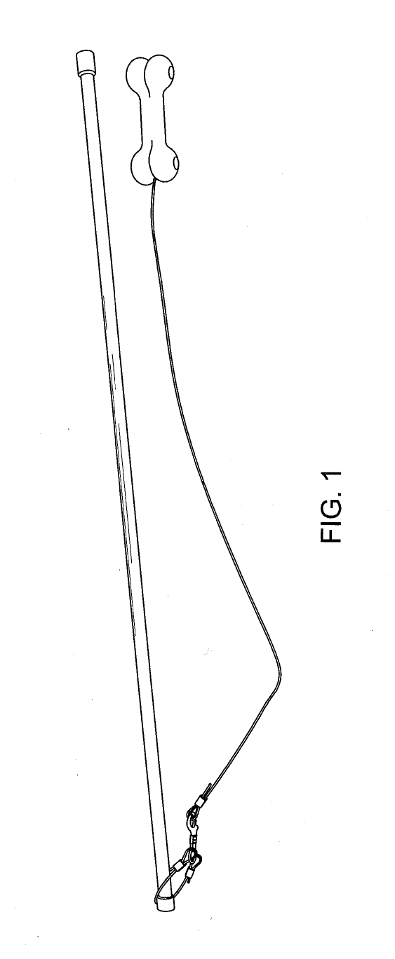

Preferred embodiments of the present invention and their advantages may be understood by referring to FIG. 1, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

FIG. 1 shows a view of a pole-based dog toy 100 of the invention. A pole 105 is provided to facilitate play. Pole 105 can comprise an approximate 5-foot long pole or stick which can be made from bamboo, wood, plastic, acrylic, fiberglass, or the like. The pole 105 can be approximately 0.5″ to 2.5″ in diameter and can either be solid or a tube/cylinder. As depicted, pole 105 includes a lower grip panel and an upper grip panel 107, which can consist of a textured portion of the pole 105 or a wrap or covering such as nylon or other type of fiber cord, leather, neoprene, rubber, plastic, or fabric. The lower end of pole 110 can comprise an end cap on the pole 105 constructed of a solid material, such as a light metal or plastic.

The upper end of pole 110 can comprise a second end cap 115 attached to pole 105 which can include a cable loop ring 120 passing through the end cap 115. The cable loop ring 120 can rotate back and forth over end cap 115 from one side of the pole 105 to the other, and slide side-to-side through the end cap 115. A swivel attachment 125 can be used to attach cable 130 to pole 105. Cable 130 can be made from a thin plastic or vinyl coated stainless steel cable or wire rope. The diameter of cable 130 can be between about 1/16″ to ¼″. The end of cable 130 opposite from pole 105 can terminate in a dog toy 135. Dog toy 135 can comprise training aids or different types of chew toys, such as toys made from fabric, leather, rawhide, plastic, rubber, or the like. An attachment interface 136 can facilitate swapping out various dog toys 135 and can include a snap swivel (which can likewise be used as swivel 125) by detaching and attaching different dog toys 135. Cable 130 can further be between about 3′ to 10′ long.

In an embodiment, the pole-based toy 100 can be easily configured to accommodate different playing styles and activities for different breeds of dogs. For example, a pit bull may require use of a ¼″ diameter cable versus a 1/16″ cable. Further, a hunting training lure for training a retriever can be swapped out for a pure toy, such as a plastic squeaky toy or pliable ball used as a chew toy.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A pole-based pet entertainment apparatus, comprising:
a pole with a first end and a second end, with the first end comprising an end cap;
said pole comprising at least two grip panels interposed between the first end and the second end;
said end cap comprising a cable hoop ring having back and forth movement over the end cap from side-to-side of the pole;
a swivel attachment attaching a cable to the cable hoop ring, said cable comprising a terminating attachment interface with an attached pet toy opposite from the cable hoop ring.

2. The pole-based pet entertainment apparatus of claim 1, wherein the swivel attachment comprises a snap swivel.

3. The pole-based pet entertainment apparatus of claim 1, wherein the terminating attachment interface comprises a snap swivel.

4. The pole-based pet entertainment apparatus of claim 1, wherein the cable comprises a plastic or vinyl coated stainless steel cable or wire rope.

5. The pole-based pet entertainment apparatus of claim 1, wherein the pole comprises bamboo, wood, plastic, acrylic, or fiberglass.

6. The pole-based pet entertainment apparatus of claim 1, wherein the cable is between about 3′ and 10′ long.

7. The pole-based pet entertainment apparatus of claim 1, wherein the pole is about 5′ long.

8. The pole-based pet entertainment apparatus of claim 1, further comprising the cable hoop ring sliding through the end cap side-to-side.

9. The pole-based pet entertainment apparatus of claim 1, wherein the cable comprises a 1/16″ to ¼″ diameter coated metal cable.

10. The pole-based pet entertainment apparatus of claim 1, wherein the dog toy comprises a training aid.

11. The pole-based pet entertainment apparatus of claim 1, wherein the dog toy comprises a chew toy.
